(19) United States
(12) Patent Application Publication
(10) Pub. No.: US 2002/0138654 A1
(43) Pub. Date: Sep. 26, 2002

(54) Apparatus, and associated method, for facilitating deletion of dictionary content pursuant to communication of signaling protocol messages

(76) Inventors: Zhigang Liu, Irving, TX (US); Khiem Le, Coppell, TX (US); Ka Cheong Leung, Irving, TX (US); Christopher Clanton, Richardson, TX (US)

Correspondence Address: NOVAKOV DAVIS & MUNCK, 900 THREE GALLERIA TOWER, 13155 NOEL ROAD, DALLAS, TX, 75240, US

(21) Appl. No.: 09/916,452

(22) Filed: Jul. 27, 2001

Related U.S. Application Data
(60) Provisional application No. 60/277,510, filed on Mar. 21, 2001.

(51) Int. Cl. G06F 15/16

(52) U.S. Cl. 709/247; 709/230

(57) ABSTRACT

Apparatus, and an associated method, for selectably deleting contents stored at a dictionary device of a sending or receiving entity. The dictionary device stores content representative of indicia associated with SIP, or other, signal protocol messages generated during operation of a communication system. A selector selects portions of the contents stored at the dictionary device to be deleted, thereby to permit additional content to be stored at the dictionary device. When separate dictionary devices are positioned at sending and receiving entities, implicit synchronous operation of selection of deletion of content at the separate dictionary devices is effectuated synchronously, but implicitly.

### CROSS-REFERENCE TO RELATED APPLICATIONS

The present invention claims the priority of provisional patent application No. 60/277,510 filed on Mar. 21, 2001, the contents of which are incorporated herein.

The present invention relates generally to communication of a signaling protocol, such as an SIP (Session Initiation Protocol), upon a bandwidth-constrained communication channel, such as the air interface defined in a 3G (third generation) IP (internet protocol) wireless communication system. More particularly, the present invention relates to apparatus, and an associated method, by which selectably to delete dictionary content stored at dictionary devices positioned at separate entities of the communication system and used in conjunction with compression and decompression operations of signaling protocol messages communicated therebetween. Implicit synchronous operation of separate dictionary content deletion mechanisms positioned at the separate entities delete the same dictionary content at the dictionary devices free of signaling separate from the signaling messages of the signaling protocol.

### BACKGROUND OF THE INVENTION

A communication system is formed, at a minimum, of a sending station and a receiving station between which data is communicated. The sending and receiving stations are interconnected by way of a communication channel. Data to be communicated by the sending station to the receiving station is converted, if necessary, into a form to permit its communication upon the communication channel. When detected at the receiving station, the informational content of the data is recovered.

Many types of communication systems have been developed and implemented to effectuate communication of data between two or more sending and receiving stations.

In some communication systems, the communication channel interconnecting the sending and receiving station is formed of a radio channel defined upon a portion of the electromagnetic spectrum. A communication system utilizing radio channels is referred to as a radio communication system. A radio communication system is inherently mobile as the radio channel interconnects the sending and receiving stations operable therein. In contrast, a conventional wire line communication system is of limited mobility due to the need to interconnect the sending and receiving stations by way of conventional, wire line connections.

A cellular communication system is a type of radio communication system which has achieved wide levels of usage and has been installed throughout large geographical areas of the world. Advancements in communication technologies have permitted the development of successive generations of cellular communication systems. Reference is commonly made to at least three generations of cellular communication systems. So-called first generation cellular communication systems generally refers to cellular communication systems which utilize analog modulation techniques. An AMPS (Advanced Mobile Phone Service) cellular communication system is exemplary of a first generation cellular communication system. A so-called second generation cellular communication system typically refers to a cellular communication system which utilizes a digital, multiple-access communication scheme. A GSM (Global System for Mobile communications) cellular communication system and an IS-95 (Interim Standard—1995), CDMA (Code-Division, Multiple-Access) cellular communication system are exemplary of second generation cellular communication systems. Third-generation cellular communication systems are presently being developed. Third-generation cellular communication systems refer generally to cellular communication systems intended to provide universal communication services including the effectuation of data services, voice services, and multi-media services.

At least one proposal under development of a third generation, cellular communication system provides an IP (internet protocol)-base radio system. In such a system, a text-based signaling protocol is to be utilized. In particular, an SIP (session initiation protocol) is to be used as a call signaling protocol to be used, e.g., to effectuate call set-up procedures. Call set-up procedures are performed, for instance, between an access network and a core network. The SIP is a text-based protocol. Other exemplary text-based protocols include SDP (session description protocol) RTSP (real time screaming protocol), and HTTP (hyper text transfer protocol).

Cellular communication systems and, more generally, many other radio communication systems, are bandwidth-constrained. That is to say, the portion of the electromagnetic spectrum available to a communication system upon which to define radio channels is limited. The limited radio channel capacity, as a result, sometimes limits the communication capacity of the communication system. Compression, and corresponding decompression, techniques are proposed by which to compress the text-based, signaling protocol messages communicated upon the radio channels defined in the cellular communication system. The signaling protocol message is compressed prior to its communication upon the radio channel. And, subsequent to communication upon the communication channel, the message is correspondingly decompressed.

A compression and decompression technique, as presently proposed, is dictionary-based. That is to say, dictionary devices are positioned at both a sending entity and a receiving entity. Dictionary devices include a memory element populated with messages which are compressed at a sending entity and, subsequently, decompressed at a receiving entity. In order to achieve correct compression and decompression, the dictionary devices at the separate entities should be the same, i.e., be populated with the same messages, in the same order.

The existing scheme, however, fails to provide a manner in which to synchronously delete the messages populated at the separate dictionary devices. As the memory elements of the dictionary devices are not of unlimited storage capacity, a need exists to provide a manner by which to remove parts of the contents stored at the dictionary devices.

A manner by which to selectably delete the dictionary-device content stored at the dictionary devices is therefore needed.

It is in light of this background information related to communications in a communication system which utilizes text-based signaling protocols that the significant improvements of the present invention have evolved.

### SUMMARY OF THE INVENTION

The present invention, accordingly, advantageously provides apparatus, and an associated method, to facilitate communications in a communication system which utilizes a signaling protocol, such as an SIP (Session Interaction Protocol) and communicates signaling protocol messages upon a bandwidth-constrained communication channel.

Through operation of an embodiment of the present invention, a manner is provided by which selectably to delete dictionary content stored at dictionary devices positioned at separate entities of the communication system and used in conjunction with compression and decompression operations of signaling protocol messages communicated therebetween.

Separate dictionary content deletion mechanisms are positioned at the separate sending and receiving entities. The dictionary content deletion mechanisms each delete the same dictionary content at the respective dictionary devices. Implicit synchronous deletion operations are performed, free of signaling separate from the signaling messages of the signaling protocol.

In one aspect of the present invention, signaling protocol messages are stored at a memory element of a dictionary device. When indicia corresponding to an additional signaling protocol message is to be stored at the dictionary device, a determination is made as to whether additional memory space is available to store the indicia of the additional signaling protocol message. If additional memory capacity is unavailable at the memory element of the dictionary device, a portion of the stored content is deleted to permit the storage of the additional indicia of the additional signal protocol message.

In another aspect of the present invention, the dictionary device is operated as a first-in, first-out storage device at which indicia representative of text-based signaling protocol messages compressed by a compressor or decompressed by a decompressor are stored. When additional dictionary content is to be stored at the dictionary device, and determination is made that previously-stored content must be deleted to permit the additional content to be stored at the dictionary device, the first-saved content is first-deleted.

In another aspect of the present invention, dictionary content deletion selectors are positioned at, or coupled to, compression and decompression elements of sending and receiving entities between which signaling protocol messages are communicated. The dictionary content deletion selectors are synchronously operable, free of special signaling between the sending and receiving entities. Because the same signaling protocol message which is compressed at a sending entity is subsequently decompressed at a receiving entity, the same content is stored at the dictionary devices of the separate entities. Because the dictionary content deletion selectors are operable pursuant to the same parameters of operation such as pursuant to identical deletion selection algorithms, identical selections are made by the separate deletion selectors without special signaling instructing the separate selectors.

In one implementation, a dictionary content deletion selector is provided to an entity, such as a base transceiver station or a mobile station operable in a 3G IP cellular communication system, to communicate SIP messages pursuant to a communication session. When an additional SIP message is communicated, indicia of the message is stored at the dictionary device. A determination is made as to whether memory capacity is available at the dictionary device to store the additional content thereat. If memory capacity is unavailable, selection is made as to what portion of the existing content of the dictionary device is to be deleted therefrom. Thereby, the additional dictionary content of the indicia associated with the SIP message is stored at the dictionary device.

If successive messages are communicated, there is a possibility that communication propagation delays might result in misordering of data packets forming the message or messages when received at a receiving entity. In operation of an embodiment of the present invention, sequence numbers of the packages are compared. And, if a misordering of packets occurs, then a delayed decision is made regarding deletion of dictionary content at the dictionary device. Thereby, for at least the delay, premature deletion selections are avoided. And, through appropriate selection of the delay period, reordering of misordered packets or messages can be adequately corrected.

In these and other aspects, therefore, apparatus, and an associated method, is provided for a communication system which utilizes a signaling protocol to effectuate signaling between a first communication station and a second communication station.

A more complete appreciation of the present invention and the scope thereof can be obtained from the accompanying drawings which are briefly summarized below, the detailed description of the presently preferred embodiments of the invention, and the appended claims.

### BRIEF DESCRIPTION OF THE DRAWINGS

FIG. 1 illustrates a functional block diagram of a communication system in which an embodiment of the present invention is operable.

FIG. 2 illustrates a functional block diagram of a portion of the communication system shown in FIG. 1, here of an alternative implementation of an embodiment of the present invention.

FIG. 3 illustrates a representation of an exemplary operation of the dictionary content deletion selector of an embodiment of the present invention.

FIG. 4 illustrates a method flow diagram listing the method of operation of an embodiment of the present invention.

### DETAILED DESCRIPTION OF THE DRAWINGS

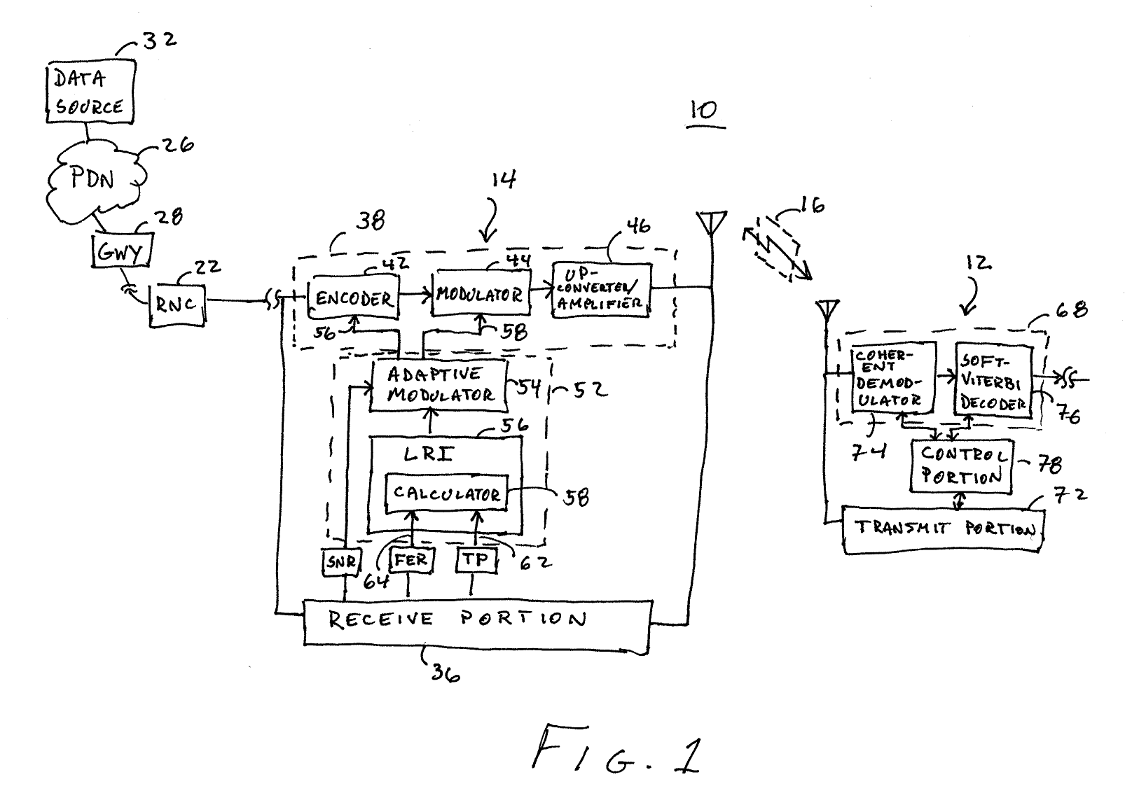

Referring first to FIG. 1, a communication system, shown generally at 10, provides for the effectuation of a communication service pursuant to a communication session with a mobile station, of which the mobile station 12 is representative. In the exemplary implementation, the mobile station 12 is operable pursuant to a so-called 3G (third generation) IP (internet protocol) cellular communication standard. More generally, though, the communication system is representative of any of many radio communication systems in which a signaling protocol, such as a text-based signaling protocol, is utilized. While the following description of the exemplary implementation shall be described with respect to a 3G, IP cellular communication system, operation of the present invention can analogously be described with its implementation in any of the various other radio communication systems.

The communication system 10 includes a network portion having a radio access network 14 which communicates data to, and receives data communicated from, the mobile station 12. Communication of data between the radio access network and the mobile station is effectuated by way of communication channels defined upon radio links formed therebetween. Here, the radio access network is connected to a packet data network (PDN) 22 such as the internet. A data source/destination device 24, such as a computer server containing database data, is coupled to the packet data network. A communication path formable between the device 24 and the mobile station 12 by way of the network part of the communication system and the radio links 16 permit data to be communicated therebetween.

The radio access network is here shown to include a proxy 26, a radio network controller (RNC) 28, and a base transceiver station 32. Additional structure, conventional of a radio access network is, for purposes of simplicity, not shown. The radio network controller is controllable to control communication operations of the radio access network, and the base transceiver station is operable to transceive data upon the communication channels defined upon the radio links 16. The base transceiver station includes a receive portion and a transmit portion. And, the radio network controller, the proxy, and other parts of the radio access network define receive and transmit portions.

Pursuant to an embodiment of the present invention, the radio access network includes the functionality of a data decompressor and a data compressor. In the exemplary implementation, such functionality is provided at a receive portion 34 and at a transmit portion 36 of the proxy 26. That is, a decompressor 38 forms part of the receive portion 34 of the proxy, and a compressor 42 forms part of the transmit portion of the proxy.

In other implementations, the functionality of the compressor and decompressor is located elsewhere in the radio access network, or at a device coupled to, or within, the packet data network. And, the functionality of such devices can further alternately be positioned at distributed locations throughout the network of the communication system.

The decompressor 38 and the compressor 42 are each operable pursuant to generation and communication of signaling protocol messages. Signaling protocol messages are generated during, for example, call set-up procedures, and during other communication operations of the communication system.

The mobile station analogously includes a receive portion 44 and a transmit portion 46. And, the receive portion 44 of the mobile station includes a decompressor 48 and the transmit portion of the mobile station includes a compressor 52. The decompressor and compressor of the mobile station are also operable pursuant to the communication of signaling protocol messages generated during operation of the communication system.

The proxy 26 in the exemplary implementation also includes a dictionary device 56 coupled to the compressor 42 and to the decompressor 38. The dictionary device includes a memory element 58 at which indicia representative of signaling messages compressed by the compressor 42 or decompressed by the decompressor 38 are stored. The dictionary device 56 is also positionable elsewhere in the network of the communication system.

Analogously, the mobile station includes a dictionary device 62 including a memory element 64. The dictionary device 62 is coupled to the decompressor and compressor 48 and 52 of the mobile station. The dictionary device 62 is also operable to store indicia representative of signaling protocol messages decompressed, and compressed, by the decompressor and compressor of the mobile station.

In the exemplary implementation in which SIP (Session Interaction Protocol) is used, the respective compressors and decompressors of the network, here at the proxy, and of the mobile station are operable to compress, or substitute, the SIP messages. Each SIP message is typically of a message length of 200-500 bytes. And, a plurality, of are required to be interchanged during a call set-up procedure. Communication of uncompressed SIP messages would therefore result in significant usage of the bandwidth capacity available on the radio links 16 and also unacceptable latency during call set-up procedure. Compression operations performed by the compressor 32 and decompressor 52 utilize the dictionary devices 56 and 62, respectively, according to a compression algorithm, such as a Lempel-Ziv algorithm, to communicate, upon the radio links 16, thereby to reduce the amount of data communicated and latency to effectuate the communication of the SIP messages. As long as the dictionary devices 56 and 62 are synchronized with one another, i.e., contain the same content, the decompressors 38 and 48 are able to reconstruct the SIP messages communicated upon the radio links by performing decompression operations thereon.

The memory capacity of the memory elements 58 and 64 of the respective dictionary devices are of finite capacity. Deletion of stored content at the respective elements must be deleted to permit additional content to be stored thereat. The proxy, accordingly, further includes, pursuant to an embodiment of the present invention, apparatus 68 operable to selectably initiate memory content deletion of content stored at the respective memory elements. And, the mobile station also correspondingly includes the apparatus 68. The apparatus 68 includes dictionary content deletion selectors, shown at 72 and 74, at the proxy and mobile station respectively.

More generally, the apparatus 68 is positioned at any sending-receiving entity pair in which compression and decompression of text-based signaling protocol messages are communicated. The deletion selectors are functional entities, implementable in any desired manner, and positionable at any desired location to be operable to select deletion of selected dictionary content stored at the dictionary devices. Selection of deletion of the dictionary content stored at the memory elements 58 and 64 is implicitly synchronous to delete the same portions, in amount and location, at the respective memory elements.

The deletion selectors are coupled to the receive and transmit portions of the respective entities to receive indications of the sizes of additional indicia to be stored at the respective memory elements. The selectors 72 and 74, responsive to such input indicia, determine whether available memory capacity at the respective memory elements are available to store the additional indicia. If so, the indicia is stored at the respective memory elements. If, however, conversely, memory capacity is not available at the memory elements to store the additional indicia, the selectors 72 and 74 are further operable to select portions of the content stored at the memory elements of the dictionary devices to be deleted.

The portions of the content stored at the respective memory elements selected to be deleted are selected pursuant to a selection criteria which is identical at both of the sending and receiving entities. Because the same content is stored at the separate memory elements and the same selection criteria is used to select which portions of the content are deleted, separate signaling between the entities to identify what portions of the dictionary content are to be deleted is not required. Thereby, the apparatus 68 provides an implicit dictionary content deletion scheme.

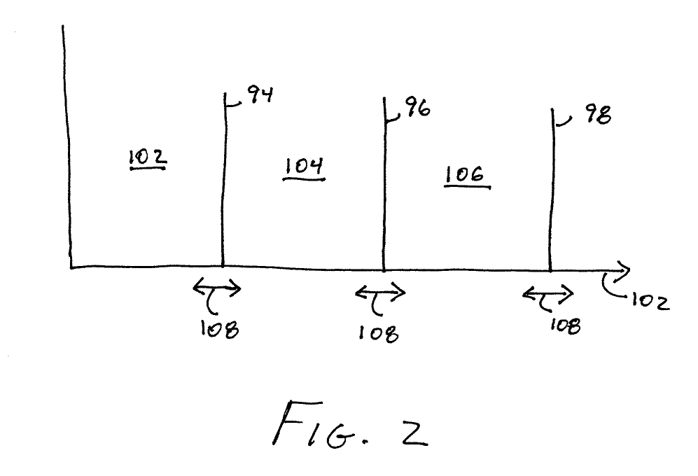

FIG. 2 illustrates sending and receiving entities formed of the proxy 26 and the mobile station 12 in which the dictionary devices 56 and 62 are formed of separate portions, portions 72-1 and 74-1, and second portions 72-2 and 74-2. The first portions are coupled to the compressors 42 and 52, respectively. And, the second portions are coupled to the decompressors 38 and 48, respectively. The selectors 72 and 74 are coupled to their respective dictionary device portions, as shown, and are operable in manners corresponding to manners described above with respect to operation of the selectors 72 and 74 shown in FIG. 1.

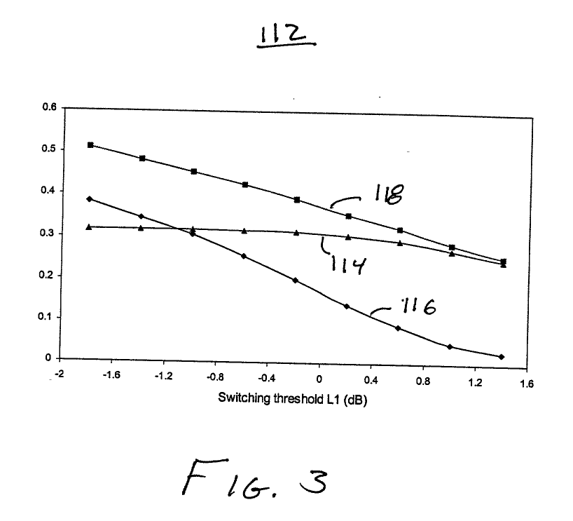

FIG. 3 illustrates exemplary operation of the apparatus 68 by which dictionary content at the dictionary devices 56 and 62 are selectably deleted. Here, the selection algorithm treats the memory elements of the dictionary devices as first-in, first-out memory devices. When dictionary content is selected to be deleted, the first-stored, i.e., the “oldest” indicia is removed prior to more-recently stored data. The first-in, first-out operation of the selection algorithm is represented as a sliding window mechanism, here indicated by the brackets 82. When an additional SIP message, represented by the block 84 is to be stored at the dictionary device, a determination is made by the selector as to whether memory capacity is available to store indicia representative of the additional SIP message. Here, the block 84 is divided into a top (as shown) and bottom (as shown) portions. In this example, not enough memory capacity is available to store the additional content and additional space, represented by the bottom portion, deletion of already-stored content must be made available to store the additional content. The first-stored memory content 86 is deleted to make space available to store the indicia, represented by the block 84, memory element. As the same algorithm is performed at both of the sending and receiving entities, implicit synchronization of memory deletion operations is effectuated.

In the event that the message is communicated between the sending and receiving entities become misordered, the possibility that the wrong portion of the content shall be deleted is minimized by delaying the dictionary content deletion.

For instance, a first message, message A, sent upon a radio link prior to transmission of a second message, message B, might arrive at a receiving entity subsequent to arrival of the second-transmitted message. The communication delay might occur, for instance, due to multi-path propagation delay. Each of the messages, or packets forming the messages, is identified with a sequence number. When the message is received at a receiving entity, analysis is initially made of the sequence number associated with each received message. If analysis determines that misordering of messages, indicated by missing sequence numbers, has occurred, delay of an earlier-transmitted message may have occurred. Selection of deletion by the selectors is delayed. Instead, the contents of the memory which would otherwise be deleted are, instead, marked with a “marker”. The marker is, for instance, a tuple, defined, e.g., in terms of a pointer and a length, indicating the contents of the memory which are to be deleted.

Then, a delay period is timed-out. Prior to expiration of the delay period, if a message, identified with the missing sequence number, is received at a receiving entity, the receiving entity then decompresses the received message using the dictionary device, prior to deletion of the marked contents. Deletion of the marked contents is performed only if the delay period times-out or the message with the missing sequence number is subsequently received. The markers associated with the marked data contents are also deleted.

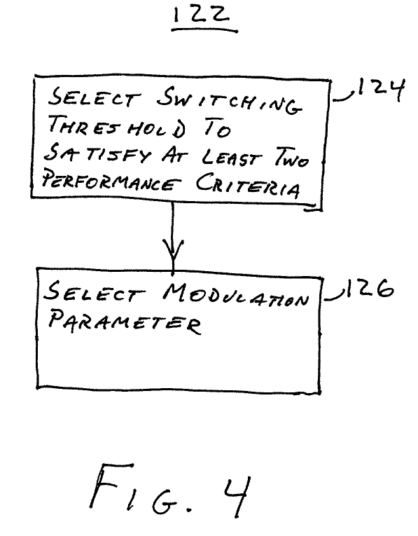

FIG. 4 illustrates a method flow diagram, shown generally at 92, of the method of operation of an embodiment of the present invention. The method 92 facilitates deletion of dictionary content stored at a first-station dictionary device associated with a first communication station. The first-station dictionary device is utilized pursuant to effectuation of signaling between first and second communication stations.

First, and as indicated by the block 94, an indication of additional dictionary content to be added to the first-station dictionary device is detected. Then, and as indicated by the block 96, selection is made of which, if any, portion of the dictionary content stored at the first-station dictionary device is to be deleted. And, as indicated by the block 98, the selected portion of the dictionary content, selected to be deleted, is deleted.

Thereby, a manner is provided by which selectably to delete dictionary content stored at the dictionary device. When paired together with a second dictionary device at a second communication station, implicit synchronous deletion of the content stored at the separate dictionary devices is effectuated.

The preferred descriptions are of preferred examples for implementing the invention and the scope of the invention should not necessarily be limited by this description. The scope of the present invention is defined by the following claims.

In the claims:

1. In a communication system which utilizes a selected signaling protocol to effectuate signaling between a first communication station and a second communication station, an improvement of apparatus for selectably facilitating deletion of dictionary content stored at a first-station dictionary device associated with the first communication station, the first-station dictionary utilized pursuant to effectuation of the signaling between the first and second communication stations, respectively, said apparatus comprising:
a first dictionary content deletion selector coupled to the first-station dictionary device, said first dictionary content deletion selector for selecting which, if any, portion of the dictionary content stored at the first-station dictionary device is to be deleted, selection made by said first dictionary content deletion selector responsive at least to an indication of additional dictionary content to be added to the first-station dictionary device.

2. The apparatus of claim 1 wherein the first-station dictionary stores indicia representative of signaling generated pursuant to effectuation of the signaling protocol, each indicia of an indicia size and wherein the indication of the additional dictionary content responsive to which said first dictionary content deletion selector is operable comprises an indication of the indicia size of the additional dictionary content to be added to the first-station dictionary device.

3. The apparatus of claim 2 wherein the indicia size of each indicia is defined in terms of a byte size, and wherein the indication of the additional dictionary content responsive to which said first dictionary content deletion selector is operable comprises an indication of the byte size of the additional dictionary content to be added to the first-station dictionary device.

4. The apparatus of claim 3 wherein the dictionary content stored at the first-station dictionary device is defined in terms of byte sizes, and wherein the selection made by said first dictionary content deletion selector is further responsive to an indication of the byte sizes of the dictionary content stored at the first-station dictionary device.

5. The apparatus of claim 4 wherein the first-station dictionary device comprises a memory element at which the dictionary content is stored, wherein the memory element exhibits a memory capacity definable in terms of bytes, and wherein the indication of the byte sizes of the dictionary content stored at the first-station dictionary device is representative of the memory capacity of the memory element less the byte sizes of the dictionary content stored at the first-station dictionary device.

6. The apparatus of claim 5 wherein said first dictionary content deletion selector further determines, responsive to the indication of the dictionary content stored at the first-station dictionary device and to the indication of the additional dictionary content to be added to the first-station dictionary device whether memory capacity is available at the memory element of the first-station dictionary device and, responsive thereto, for selecting which, if any, portion of the dictionary content stored at the first-station dictionary device is to be deleted.

7. The apparatus of claim 1 wherein the first-station dictionary device comprises a FIFO (first-in, first-out)-structured memory device and wherein the dictionary content, if any, selected by said first dictionary content deletion selector to be deleted comprises first-in dictionary content.

8. The apparatus of claim 7 wherein the first-in dictionary content is selected to be deleted in amounts corresponding to amounts for the additional dictionary content indicated to be added to the first-station dictionary device.

9. The apparatus of claim 1 wherein the first-station dictionary device is embodied at an entity having both a compressor for compressing an outgoing protocol signal originated at the first communication station and a decompressor for decompressing an incoming message originated at the second communication station, wherein the first-station dictionary device is coupled to both the compressor and the decompressor, and wherein the indication of the additional dictionary content responsive to which said first dictionary content deletion selector makes the selection, includes additional dictionary content associated with either incoming and outgoing messages.

10. The apparatus of claim 1 wherein the first-station dictionary device is embodied at an entity having a compressor for compressing an outgoing protocol signal originated at the first communication station, wherein the first-station dictionary device includes a first portion coupled to the compressor, and wherein the indication of the additional dictionary content responsive to which the said first dictionary content deletion selector makes the selection includes additional dictionary content associated with the outgoing protocol signal.

11. The apparatus of claim 10 wherein the entity at which the first-station dictionary device is embodied further has a decompressor for decompressing an incoming protocol signal originated at the second communication station, wherein the first-station dictionary device further includes a second portion coupled to the decompressor, and wherein the indication of the additional dictionary content responsive to which said first dictionary content deletion selector makes the selection includes additional dictionary content associated with the incoming protocol signal.

12. In the communication system of claim 1, wherein the apparatus further selectably facilitates deletion of dictionary content stored at a second-station dictionary device associated with the second communication station, the second-station dictionary also utilized pursuant to effectuation of the signaling between the first and second communication stations, said apparatus further comprising:
a second dictionary content deletion selector coupled to the second-station dictionary device, said second dictionary content deletion selector for selecting which, if any, portion of the dictionary content stored at the second-station dictionary device is to be deleted, selection made by said second dictionary content deletion selector responsive at least to an indication of additional dictionary content to be added to the second station dictionary device.

13. The apparatus of claim 12 wherein said first dictionary content deletion selector and said second dictionary content deletion selector are synchronously operable during a communication session during which the signaling protocol is effectuated between the first communication station and the second communication station.

14. The apparatus of claim 13 wherein said first dictionary content deletion selector and said second dictionary content deletion selector are implicitly synchronously operable during the communication session, free of explicit signaling therebetween separate from the signaling protocol.

15. The apparatus of claim 1 wherein the signaling protocol effectuated between the first communication station and the second communication station comprises a first signaling protocol message and at least a second signaling protocol message originated at the second communication station and sent to the first communication station, each of the first and at least second signaling protocol messages identified by a sequence number, and wherein selection made by said first dictionary content deletion selector is further responsive to the sequence number of the additional dictionary content formed of at least one of the first and at least second signaling protocol messages.

16. In a method for communicating in a communication system which utilizes a selected signaling protocol to effectuate signaling between a first communication station and a second communication station, an improvement of a method for selectably facilitating deletion of dictionary content stored at a first-station dictionary device associated with the first communication station, the first-station dictionary utilized pursuant to effectuation of the signaling between the first and second communication stations, respectively, said method comprising:
detecting an indication of additional dictionary content to be added to the first-station dictionary device; and
selecting, at least responsive to the indication detected during said operation of detecting, which, if any, portion of the dictionary content stored at the first-station dictionary device is to be deleted.

17. The method of claim 16 further comprising the operation of deleting the portion of the dictionary content stored at the first-station dictionary device selected during said operation of selecting.

18. In the method for communicating of claim 16, wherein the method for selectably facilitating deletion of dictionary content is further for selectably facilitating deletion of dictionary content stored at a second-station dictionary device associated with the second communication station, the second-station dictionary also utilized pursuant to effectuation of the signaling between the first and second communication stations, said method comprising:
detecting an indication of additional dictionary content to be added to the second station dictionary device; and
selecting, at least responsive to the indication of the additional dictionary content to be added to the second-station dictionary device, which, if any, portion of the dictionary content stored at the second-station dictionary device is to be deleted.

19. The method of claim 18 wherein said operations of selecting are synchronously performed during a communication session during which the signaling protocol is effectuated between the first communication station and the second communication station.

20. The method of claim 19 wherein said operations of selecting are implicitly synchronously performed, free of explicit signaling separate from the signaling protocol.
